(19) United States
(12) Patent Application Publication
(10) Pub. No.: US 2012/0131513 A1
(43) Pub. Date: May 24, 2012

(54) Gesture Recognition Training

(75) Inventor: Peter John Ansell, Watford (GB)

(73) Assignee: Microsoft Corporation, Redmond, WA (US)

(21) Appl. No.: 12/950,551

(22) Filed: Nov. 19, 2010

(51) Int. Cl. G06F 3/033

(52) U.S. Cl. 715/863

(57) ABSTRACT

Gesture recognition training is described. In an example, a gesture recognizer is trained to detect gestures performed by a user on an input device. Example gesture records, each showing data describing movement of a finger on the input device when performing an identified gesture are retrieved. A parameter set that defines spatial triggers used to detect gestures from data describing movement on the input device is also retrieved. A processor determines a value for each parameter in the parameter set by selecting a number of trial values, applying the example gesture records to the gesture recognizer with each trial value to determine a score for each trial value, using the score for each trial value to estimate a range of values over which the score is a maximum, and selecting the value from the range of values.

### BACKGROUND

Many computing devices allow touch-based input, such as notebook computers, smart phones and tablet computers. Some of these devices also offer gesture-based input, where a gesture involves the motion of a user's hand, finger, body, etc. An example of a gesture-based input is a downwards stroke on a touch-sensor which may translate to scrolling the window downwards.

Multi-touch gesture-based interaction techniques are also becoming increasingly popular, where the user interacts with a graphical user interface using more than one finger to control and manipulate a computer program. An example of a multi-touch gesture-based input is a pinching movement on a touch-sensor which may be used to resize (and possibly rotate) images that are being displayed.

To enable gesture-based interaction, these computing devices comprise gesture recognizers in the form of software which translates the touch sensor information into gestures which can then be mapped to software commands (e.g. scroll, zoom, etc). These gesture recognizers operate by tracking the shape of the strokes made by the user on the touch-sensor, and matching these to gesture templates in a library. However, this technique is complex and hence either uses a significant amount of processing or is slow and results in a gesture recognition lag. Furthermore, the technique can be inaccurate if the shape matching is not precise, leading to unintended commands being executed.

Furthermore, as the popularity of multi-touch input increases, new types of multi-touch input devices are also being developed. For example, multi-touch mouse devices have been developed that combine touch input with traditional cursor input in a desktop computing environment. However, these new devices bring with them new constraints and requirements in terms of gesture recognition. For example, in the case of multi-touch mouse devices, the user is holding, picking up and moving the device in normal use, which results in incidental or accidental inputs on the touch-sensor. Current gesture recognizers do not distinguish between incidental inputs on the touch-sensor and intentional gestures.

The embodiments described below are not limited to implementations which solve any or all of the disadvantages of known gesture recognition techniques.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Gesture recognition training is described. In an example, a gesture recognizer is trained to detect gestures performed by a user on an input device. Example gesture records, each showing data describing movement of a finger on the input device when performing an identified gesture are retrieved. A parameter set that defines spatial triggers used to detect gestures from data describing movement on the input device is also retrieved. A processor determines a value for each parameter in the parameter set by selecting a number of trial values, applying the example gesture records to the gesture recognizer with each trial value to determine a score for each trial value, using the score for each trial value to estimate a range of values over which the score is a maximum, and selecting the value from the range of values.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 illustrates a computing system having a multi-touch mouse input device;

FIG. 2 illustrates a mapping of zones on an input device to a region definition;

FIG. 3 illustrates the recognition of an example pan gesture;

FIG. 4 illustrates an example gesture recognizer parameter set;

FIG. 5 illustrates a flowchart of a process for determining values for parameters in the parameter set;

FIG. 6 illustrates a flowchart of a process for optimizing a parameter value;

FIG. 7 illustrates an example of an optimization process; and

FIG. 8 illustrates a flowchart of a process for scoring a parameter value;

FIG. 9 illustrates an exemplary computing-based device in which embodiments of the gesture recognition training technique may be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Although the present examples are described and illustrated herein as being implemented in a desktop computing system using a multi-touch mouse, the system described is provided as an example and not a limitation. As those skilled in the art will appreciate, the present examples are suitable for application in a variety of different types of computing systems, using a variety of different input devices.

Described herein is a technique to enable fast and accurate gesture recognition on input devices (such as multi-touch mouse devices) whilst having low computational complexity. This is achieved by training the gesture recognizer in advance to use different types of readily detectable spatial triggers to determine which gestures are being performed. By training parameters that define the spatial triggers in advance the computational complexity is shifted to the training process, and the computations performed in operation when detecting a gesture are much less complex. Furthermore, because the spatial features are readily calculated geometric features, they can be performed very quickly, enabling rapid detection of gestures with low computational requirements. This is in contrast to, for example, a machine learning classifier approach, which, although trained in advance, still uses significant calculation when detecting gestures, thereby using more processing power or introducing a detection lag.

Firstly, the types of spatial triggers and the way they can be used to detect gestures are described below. Secondly a technique for training the spatial triggers in advance is described.

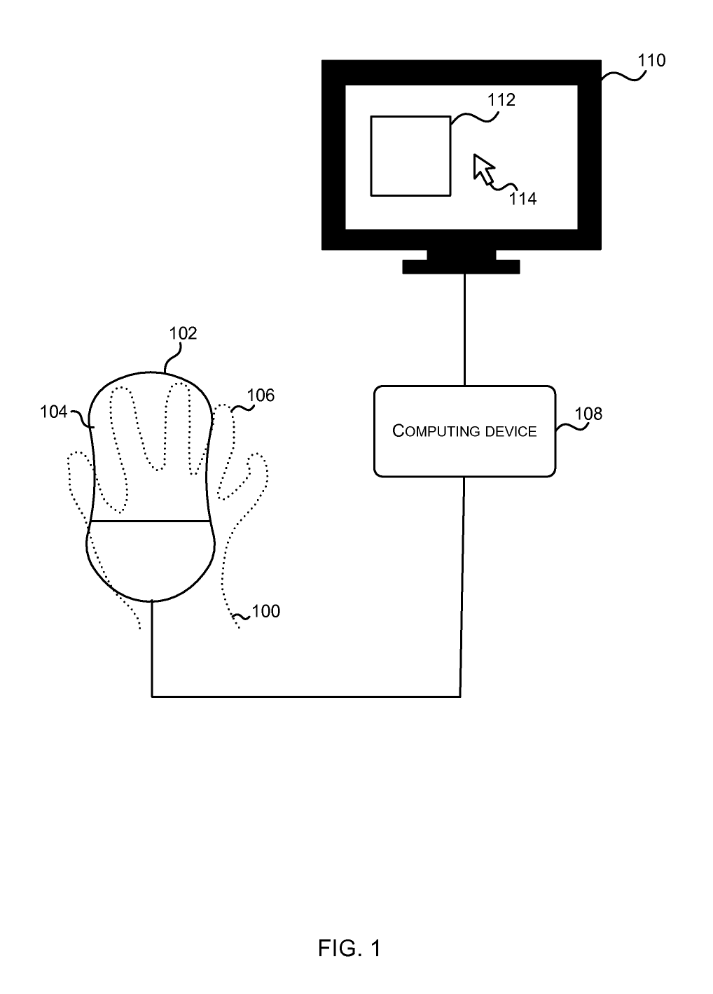

Reference is first made to FIG. 1 which illustrates a computing system having a multi-touch mouse input device. A user is using their hand 100 to operate an input device 102. In the example shown in FIG. 1, the input device 102 is a multi-touch mouse device. The term “multi-touch mouse device” is used herein to describe any device that can operate as a pointing device by being moved by the user and can also sense gestures performed by the user's digits.

The input device 102 of FIG. 1 comprises a touch-sensitive portion 104 on its upper surface that can sense the location of one or more digits 106 of the user. The touch-sensitive portion can, for example, comprise a capacitive or resistive touch sensor. In other examples, optical (camera-based) or mechanical touch sensors can also be used. In further examples, the touch-sensitive region can be located at an alternative position, such as to the side of the input device.

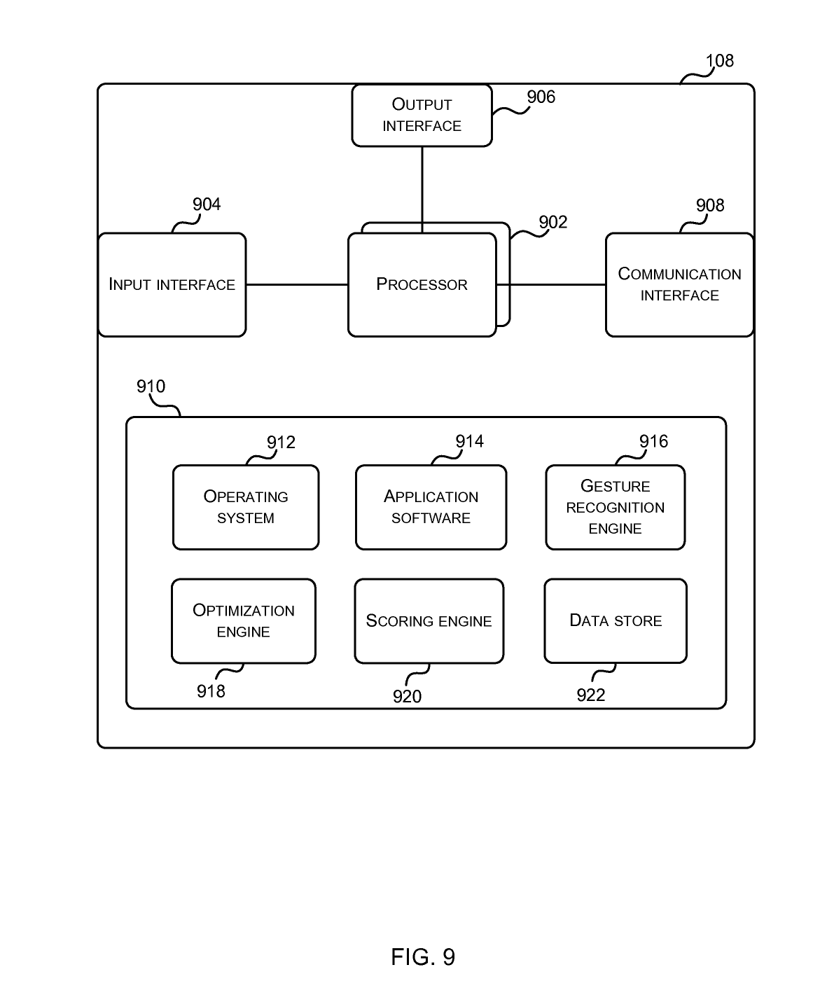

The input device 102 is in communication with a computing device 108. The communication between the input device 102 and the computing device 108 can be in the form of a wireless connection (e.g. Bluetooth) or a wired connection (e.g. USB). More detail is provided on the internal structure of the computing device with reference to FIG. 9, below. The computing device 108 is connected to a display device 110, and is arranged to control the display device 110 to display a graphical user interface to the user. The graphical user interface can, for example, comprise one or more on-screen objects 112 and a cursor 114.

In use, the user can move the input device 102 (in the case of a multi-touch mouse) over a supporting surface using their hand 100, and the computing device 108 receives data relating to this motion and translates this to movement of the on-screen cursor 114 displayed on the display device 110. In addition, the user can use their digits 106 to perform gestures on the touch-sensitive portion 104 of the input device 102, and data relating to the movement of the digits is provided to the computing device 108. The computing device 108 can analyze the movement of the digits 106 to recognize a gesture, and then execute an associated command, for example to manipulate on-screen object 112.

Note that in alternative examples to that shown in FIG. 1, different types of input device can be used. For example, the input device can be in the form of a touch-pad or the display device 108 can be a touch-sensitive screen. Any type of input device that is capable of providing data relating to gestures performed by a user can be used.

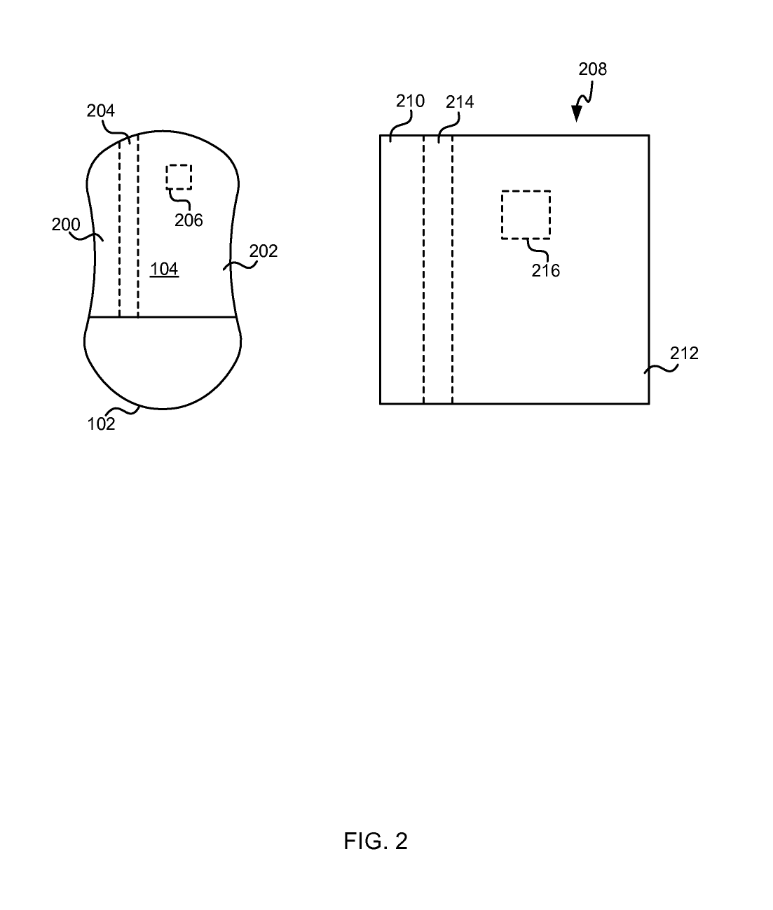

The gesture recognition technique that can be used in the system of FIG. 1 is based on two types of spatial trigger: “regions” and “thresholds”, as described in more detail below. “Regions” refers to spatial regions (or zones) on the input device from which certain gestures can be initiated. This is illustrated with reference to FIG. 2, which shows the input device 102 having touch-sensitive portion 104 divided into a number of zones.

A first zone 200 corresponds to an area on the touch-sensitive portion that is predominantly touched by the user's thumb. Therefore, it can be envisaged that gestures that start from this first zone 200 are likely to be performed by the thumb (and potentially some other digits as well). A second zone 202 corresponds to an area on the touch-sensitive portion that is predominantly touched by the user's fingers. A third zone 204 is an overlap zone between the first and second zones, where either a finger or thumb are likely to touch the touch-sensitive portion. A fourth zone 206 corresponds to an area of the touch-sensitive portion 104 that the user is likely to touch when performing fine-scale scrolling gestures (e.g. in a similar location to a scroll-wheel on a regular mouse device). Note that, in some examples, the regions may not be marked on the input device, and hence may not be directly visible to the user.

FIG. 2 also shows a definition of a plurality of regions 208 corresponding to the zones on the touch-sensitive portion 104. The definition of the plurality of regions 208 can be in the form of a computer-readable or mathematical definition of where on the touch-sensitive portion 104 the zones are located. For example, a coordinate system relative to the touch sensor of the touch-sensitive portion can be defined, and the plurality of regions defined using these coordinates.

The example of FIG. 2 has a first region 210 corresponding to the first zone 200 (e.g. the thumb zone), a second region 212 corresponding to the second zone 202 (e.g. the finger zone), a third region 214 corresponding to the third zone 204 (e.g. the overlap zone), and a fourth region 216 corresponding to the fourth zone 206 (e.g. the sensitive scroll zone).

Therefore, by using the definition of the plurality of regions 208, the computing device 108 can determine which zone of the touch-sensitive portion 104 a detected touch is located in, from the coordinates of the detected touch. Note that, in other examples, many other zones can also be present, and they can be positioned and/or oriented a different manner. Also note that whilst the definition of the plurality of regions 208 is shown as a rectangular shape in FIG. 2, it can be any shape that maps onto the coordinates of the touch-sensor of the input device 102.

The training techniques described below enable the shape, size and location of the zones on the input device to be optimized in advance using data from users of the input device, such that they are positioned so as to be effective for the majority of users. In other words, knowledge of how the input device is used by the user enables the touch-sensitive portion of the input device to be divided into regions, each associated with a distinct set of gestures. This reduces the amount of time spent searching for matching gestures, as only those that can be performed from certain regions are searched.

The second type of spatial trigger, “thresholds”, refers to limits that a movement crosses to trigger recognition of a gesture. Thresholds can be viewed conceptually as lines drawn on the definition of the plurality of regions 208, and which must be crossed for a gesture to be detected. These thresholds can be in the form of straight lines or curved lines, and are referred to herein as “threshold vectors”.

Each gesture in each set of gestures is associated with at least one threshold vector. When movement of a digit on the touch-sensitive portion 104 is detected, and a start coordinate is recorded, then the threshold vectors for each of the gestures applicable to the region in which the start coordinate is located are determined. The threshold vectors are defined with reference to the start coordinate. Conceptually, this can be envisaged as placing each threshold vector for the gestures that are available in the region in question at a predefined location relative to the start coordinate of the digit.

As an illustrative example, consider a digit having a start coordinate of (7,12). The set of gestures for the region in which point (7,12) exists has, for example, two threshold vectors: a first one having a displacement of 5 units vertically upwards, and 3 units to the left; and a second having a displacement of 2 units vertically downwards , and 4 units to the right. Therefore, in this example, the computing device determines that the origin of the threshold vectors need to be located at (12,9) and (5,16). The threshold vectors also have a magnitude and direction (and/or optionally curvature) starting from these origins.

For each digit that is moving (i.e. has moved from a start coordinate), the current coordinate of the digit is compared to each threshold vector that applies for that digit. It is then determined whether that digit at its current coordinate has crossed a threshold vector. If the current coordinate of a digit indicates that the contact point has crossed a threshold vector relative to its start coordinate, then the gesture associated with the crossed threshold vector is detected, and an associated command is executed. Gestures that use multiple digits can be detected in a similar manner, except that, for a multi-digit gesture, threshold vectors for each of the digits are crossed before the gesture is triggered.

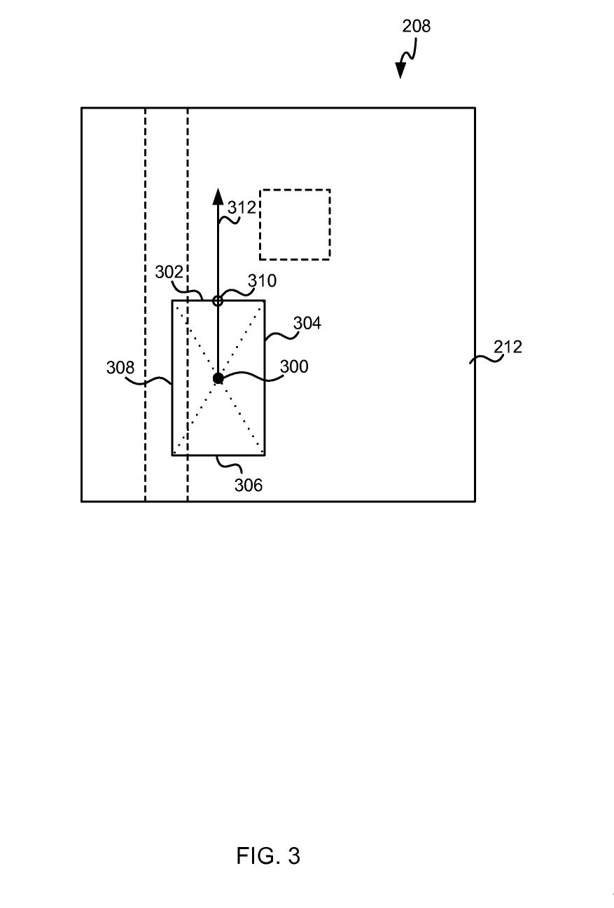

FIG. 3 shows the recognition of an example pan gesture on the plurality of regions 208. The user starts moving their digit from a point on the touch-sensitive portion 104 of the input device 102 that corresponds with start coordinate 300 shown in FIG. 3. Start coordinate 300 is located in the second (finger) region 212. The computing device 108 determines that the second region 212 is associated with a certain set of gestures. A noted above, each gesture in this set of gestures is associated with at least one threshold vector. The computing device 108 determines where each of the threshold vectors for each of the gestures is located, relative to the start coordinate 300.

For example, FIG. 3 shows, as an illustration, a set of four gestures, each having one threshold vector. Shown in FIG. 3 is a pan-up gesture having an associated pan-up threshold vector 302, a pan-right gesture having an associated pan-right threshold vector 304, a pan-down gesture having an associated pan-down threshold vector 306, and a pan-left gesture having an associated pan-left threshold vector 308. In other examples, more gestures can be present in the set of gestures for the second region 212, but these are not illustrated here for clarity.

The combination of the four gestures illustrated in FIG. 3 form a rectangle around the start coordinate 300. At each frame of motion of the user's digit, it is checked whether the current coordinate of the digit has crossed any of the four threshold vectors. In other words, it is determined whether the movement of the user's digit has brought the digit outside the rectangle formed by the four threshold vectors.

FIG. 3 shows the example of the user's digit moving vertically upwards, and at point 310 the path of the movement crosses the pan-up threshold vector 310. Because the pan-up gesture is a single-digit gesture in this example, the gesture can be triggered immediately by the one digit crossing the threshold. The pan-up gesture is then detected and executed, such that subsequent movement of the user's digit, for example following vertical path 312, is tracked and provides input to control the user interface displayed on display device 110. For example, the user can pan-up over an image displayed in the user interface by an amount proportional to the vertical path 312 traced by the user's digit.

The use of threshold vectors to detect and trigger the gestures can be performed rapidly and without extensive computation, unlike shape matching techniques. This allows a large number of gestures to be included with minimal computational overhead. The process operates as a simple “race” to find the first threshold vector that is crossed (by multiple digits in some examples). In addition, the use of threshold vectors ensures that positive movements have to be made to cross a threshold and trigger a gesture, reducing inadvertent gesture triggering. Like the definition of the regions, the position and size of the threshold vectors is also trained and optimized in advance, to enable the input device to accurately detect gestures for users immediately when used.

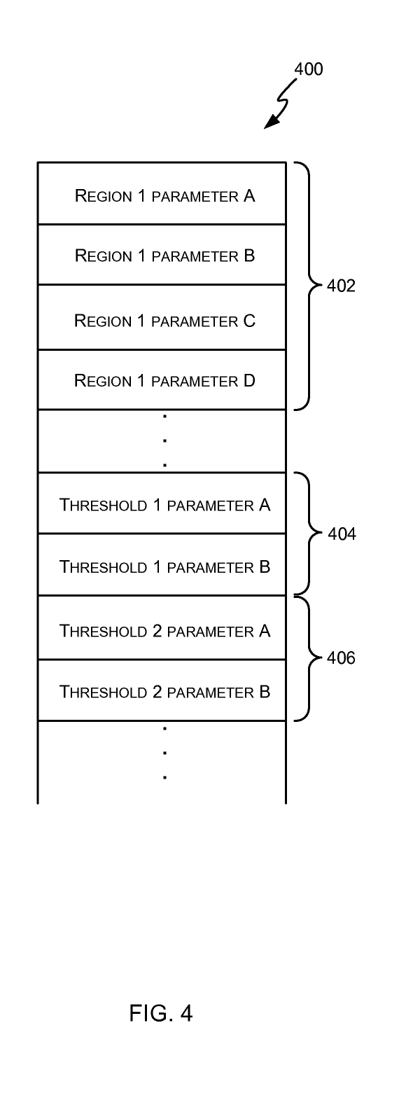

The process for training and optimization of the regions and thresholds is now described. The regions and thresholds can be represented as a set of parameters, for example as illustrated in FIG. 4. FIG. 4 shows a parameter set 400 for the gesture recognizer that comprises four parameters defining a first region 402 (“region 1”), two parameters defining a first threshold 404 (“threshold 1”), and two parameters defining a second threshold 406 (“threshold 2”). In alternative examples, more regions and thresholds can be defined in the parameter set, each of which can be defined using more or fewer parameters.

The parameters can define the position and size of the regions and thresholds in any suitable way. For example, the regions can be defined using four coordinates, each defining the location of a corner of the region on the touch-sensitive portion 104. Similarly, the thresholds can be defined using two coordinates, defining the start and end point of the threshold relative to the start coordinate of the gesture. However, in other examples, the regions and thresholds can be represented using alternative definitions, such as using areas, orientations, or mathematical descriptions. In one example, the parameter set 400 can be presented as an XML document.

The aim of the training and optimization process is to determine values for each of the parameters in the parameter set 400. Once the values for the parameters have been optimized, then the gesture recognizer can use these values when subsequently receiving real-time input from a user, and rapidly detect gestures using the optimized definitions of the regions and thresholds.

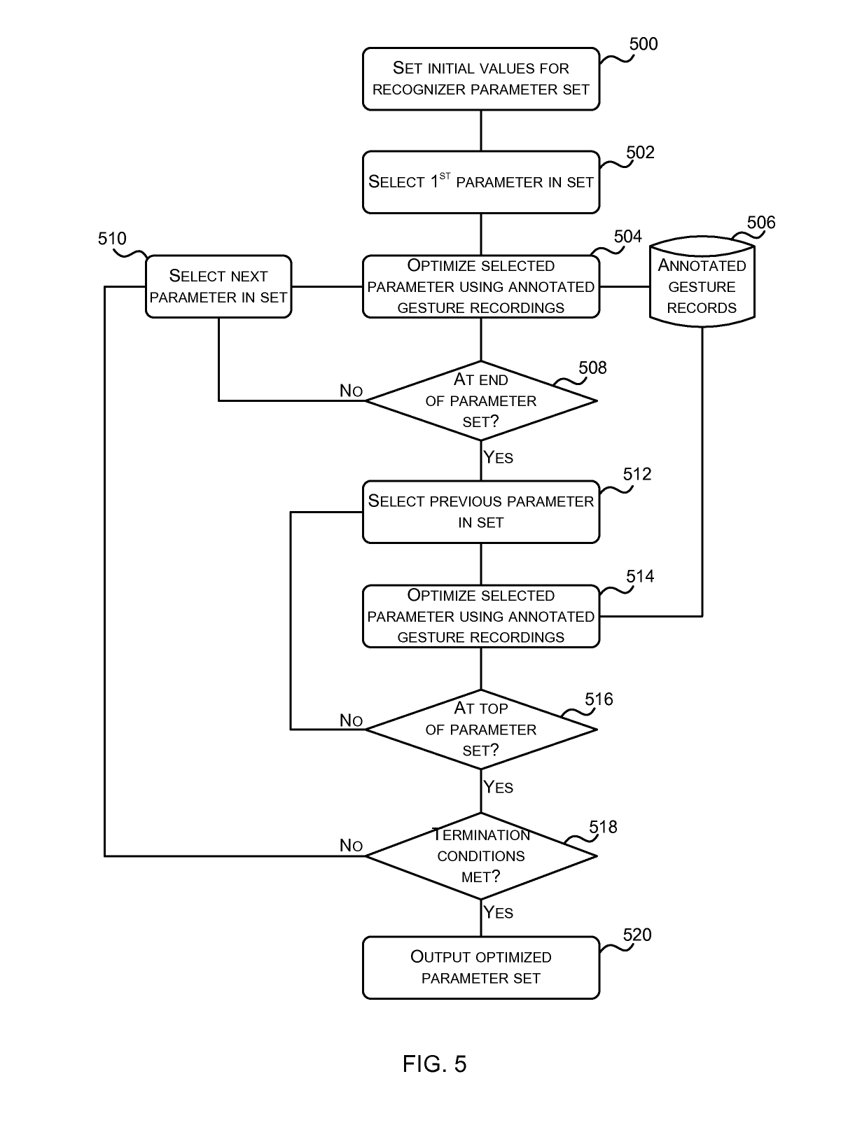

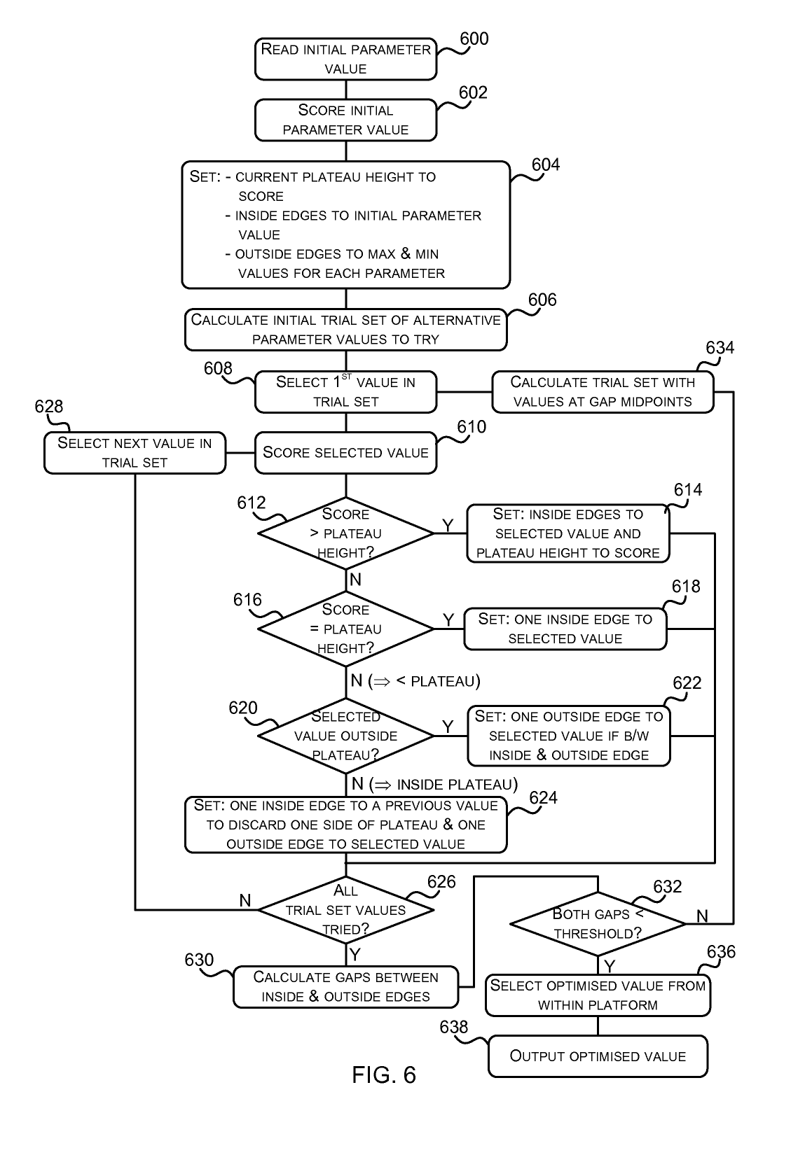

Reference is now made to FIG. 5 which illustrates a flowchart of a process for determining values for parameters in the parameter set 400. Firstly, initial values are set 500 for the parameters in the parameter set. These initial values can, for example, be randomly chosen or manually selected based on prior knowledge. The first parameter in the parameter set 400 is then selected 502, and the first parameter is optimized 504 using a plurality of annotated example gesture records 506. A detailed flowchart of the process for optimizing the parameter is described below with reference to FIG. 6.

Each annotated example gesture record comprises pre-recorded data describing movement of at least one digit on the input device when performing an identified gesture. This data can be obtained, for example, by recording a plurality of users making a variety of gestures on the input device. In addition, recordings can also be made of the user performing non-gesturing interaction with the input device (such as picking up and releasing the input device). The data for the recordings can then be annotated to include the identity of the gesture being performed (if any). In other examples, rather than using data recorded from real users operating the input device, the example gesture recordings can be artificially generated simulations of users performing gestures.

Once the first parameter has been optimized, it is determined 508 whether the process has reached the end of the parameter set 400. If not, then the next parameter in the parameter set 400 is selected 510, and optimized 504 using the example gesture records 506.

Once it is determined 508 that the end of the parameter set 400 has been reached, then the previous parameter in the parameter set 400 is selected 512, and optimized 514 using the example gesture records 506 (as described in more detail in FIG. 6). In other words, after going through the parameter set 400 optimizing each parameter in a first (forward) sequence, the process now starts going backwards through the parameter set in the opposite (reverse) sequence.

It is then determined 516 whether the process has returned to the top (i.e. first) parameter in the parameter set 400, and, if not, the previous parameter is selected 512 and optimized 514. If it is determined 516 that the top of the parameter set 400 has been reached, then it is determined 518 whether termination conditions have been met.

The termination condition can be a determination of whether the optimized parameter values have reached a steady state. This can be determined by comparing one or more of the parameter values between each optimization (i.e. the one in the first sequence, and the one in the opposite sequence). If the parameter's values have changed by less than a predetermined threshold between each optimization, then it is considered that a steady state has been reached, and the termination conditions are met. In other examples, difference termination conditions can be used, such as a time-limit on the length of time that the process is performed for, or a number of forward and reverse optimizations through the parameter set that are to be performed.

If it is determined 518 that the termination conditions have not been met, then the next parameter in the parameter set is selected 510, and the process of the optimizing each parameter in the parameter set in a forward and reverse direction is repeated. If, however, it is determined 518 that the termination conditions have been met, then the optimization process for the parameter set 400 is complete, and the optimized parameter set is output 520. The optimized parameter set 400 can then subsequently be used by the gesture recognizer to detect gestures in real-time on the input device.

Reference is now made to FIG. 6, which illustrates a flowchart of a process for optimizing a parameter value. The process of FIG. 6 can be performed for a given parameter at each of the optimization stages mentioned above for FIG. 5.

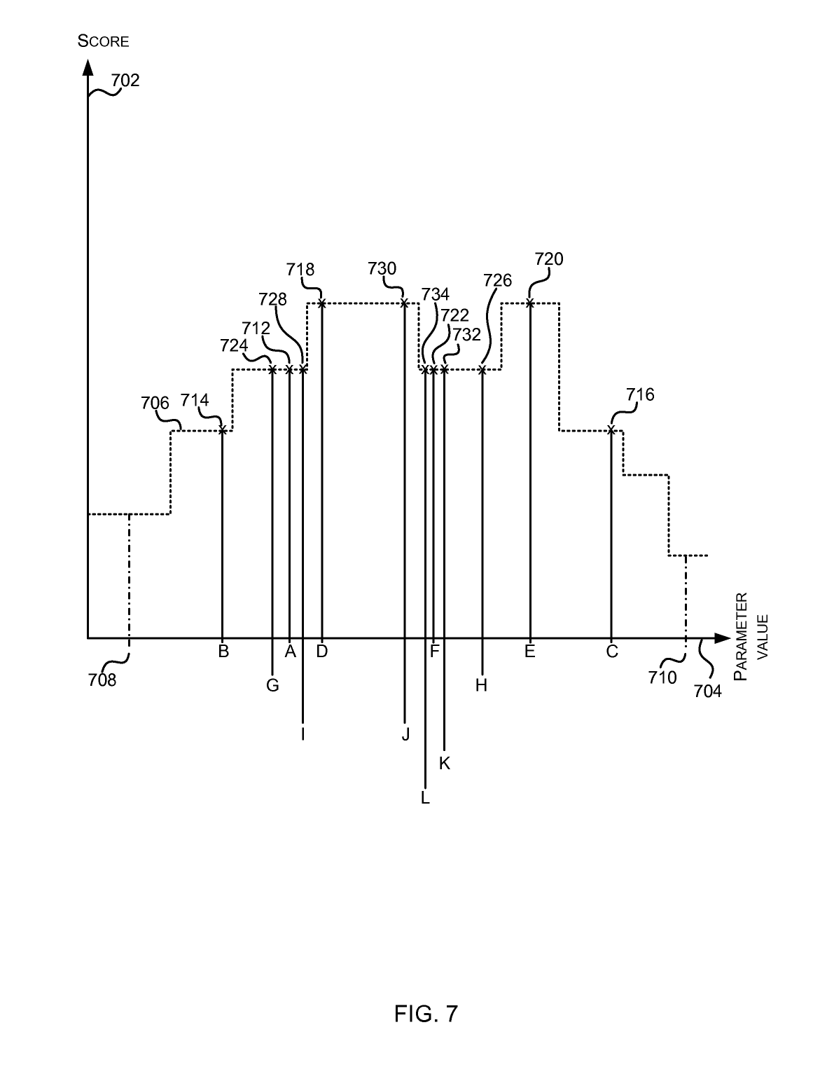

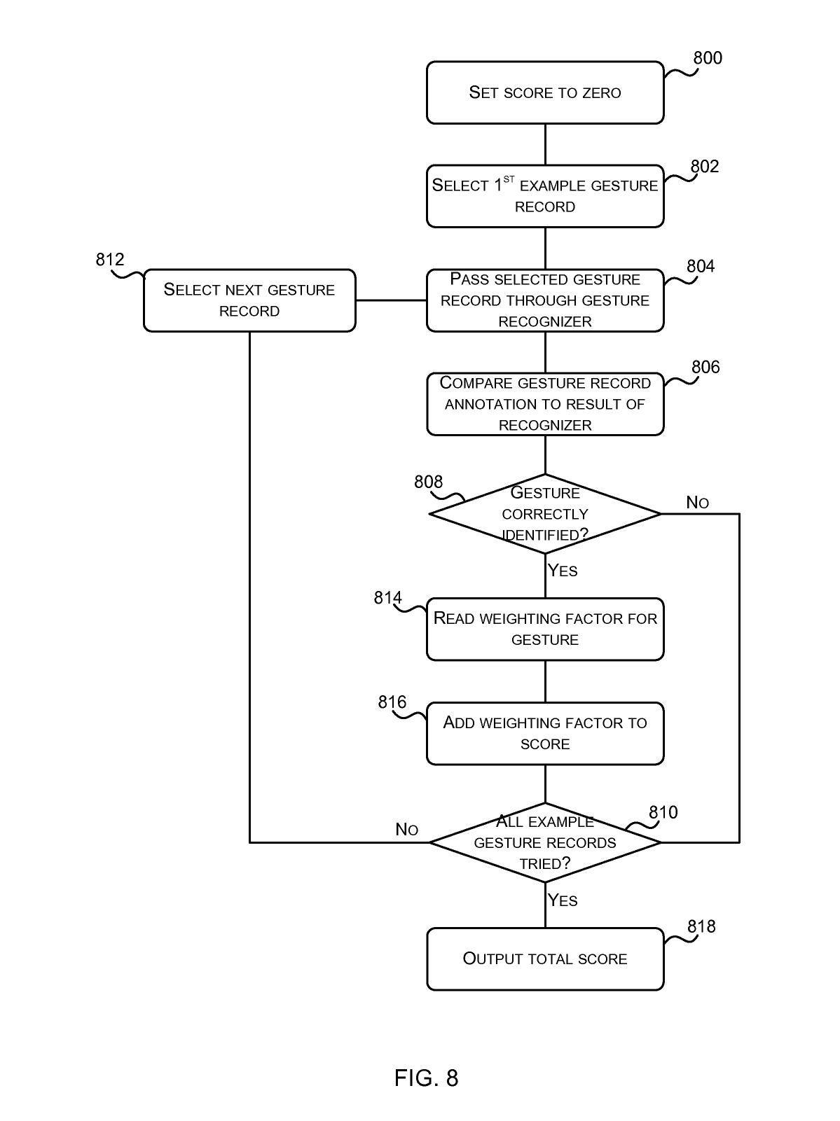

Firstly, the initial parameter value is read 600, and a “score” for the initial parameter value is determined 602. The process for scoring a parameter value is described below in more detail with reference to FIG. 7. In general, the score provides a quantification of how well the parameter value performs in recognizing the example gesture records. The optimization process maintains five variables, each of which can be initialized and set 604 once the score for the initial parameter value has been determined. These variables all relate to features of a plot of score versus parameter value. An example of such a plot is illustrated in FIG. 8 and described below.

The first variable is a “plateau height” variable. The plateau height variable refers to the height of a region in the plot over which the score has a maximum value. In other words, the plateau height variable corresponds to the maximum score measured. The plateau height variable is initialized to the score for the initial parameter value.

The second and third variables are lower and upper inside edge variables. The lower inside edge variable refers to the smallest parameter value measured at which it has been determined that the score is on the plateau. The lower inside edge variable is initialized to the initial parameter value. The upper inside edge variable refers to the largest parameter value measured at which it has been determined that the score is on the plateau. The upper inside edge variable is also initialized to the initial parameter value.

The fourth and fifth variables are lower and upper outside edge variables. The lower outside edge variable refers to the largest parameter value measured before the score reaches the plateau. In other words, the lower outside edge variable is the largest value known to be less than the lower edge of the plateau. The lower outside edge variable is initialized to a predefined minimum value for the parameter. The upper outside edge variable refers to the smallest parameter value measured after the score has dropped off from the plateau. In other words, the upper outside edge variable is the smallest value known to be greater than the upper edge of the plateau. The upper outside edge variable is initialized to a predefined maximum value for the parameter.

The overall aim of the optimization algorithm is to sample various trial parameter values and determine the corresponding scores, and use the scores for each trial value to estimate a range of parameter values over which the score is a maximum. In other words, the sampling attempts to determine the extent of the plateau by estimating the parameter values at the upper and lower edges of the plateau. This is achieved by sampling trial parameter values and updating the variables above until reliable estimates for upper and lower edges of the plateau are found. Once the upper and lower edges of the plateau are determined, an optimum parameter value can be selected from the plateau.

An initial trial set of alternative parameter values to sample is selected 606. In one example, the initial trial set can be a number of parameter values that are substantially evenly spaced between the predefined minimum and maximum values for the parameter. In other examples, different initial trial sets can be selected, for example a random selection of values between the predefined minimum and maximum values for the parameter.

The first value in the trial set is selected 608, and is scored 610 as outlined below with reference to FIG. 7. It is then determined 612 whether the score for the trial value is greater than the current value for the plateau height variable. If so, then both the lower and upper inside edge variables are set 614 to the selected trial parameter value, and the plateau height variable is updated to the score for the trial value. In other words, a better estimate for the plateau has been found, and the variables updated accordingly.

If not, then it is determined 616 whether the score for the selected trial value is equal to the current plateau height variable. If so, this indicates that the estimate of the inside edge of the plateau ought to be extended, and one of the lower or upper inside edge variables are set 618 to the selected trial parameter value. Which one of the lower or upper inside edge variables are set to the selected trial parameter value depends upon which side of the plateau the trial parameter value is located. For example, if the trial parameter value is less than the current lower inside edge variable, then it is the lower inside edge variable that is set to the selected trial parameter value. Conversely, if the trial parameter value is greater than the current upper inside edge variable, then it is the upper inside edge variable that is set to the selected trial parameter value.

If it is determined 616 that the score for the selected trial value is not equal to the current plateau height variable, then this implies that the score is less than the current plateau height variable. It is then determined 620 whether, given that the score is less than the current plateau height variable, the trial parameter value is outside the current plateau (i.e. not between the lower and upper inside edge variables). If so, then one of the lower or upper outside edge variables are set 622 to the selected trial value if the trial value is between either the lower inside and outside edge, or the upper inside and outside edge. In other words, a closer estimate of the outside edge of the plateau has been found. Which one of the lower or upper outside edge variables are set to the selected trial parameter value depends upon which side of the plateau the trial parameter value is located. For example, if the trial parameter value is less than the current lower inside edge variable, then it is the lower outside edge variable that is set to the selected trial parameter value. Conversely, if the trial parameter value is greater than the current upper inside edge variable, then it is the upper outside edge variable that is set to the selected trial parameter value.

If it is determined 620 that the trial parameter value is inside the current plateau (i.e. between the lower and upper inside edge variables), then this means that the current estimate of the extent of the plateau is incorrect, as a lower score has been found within it. In this case, one of the upper or lower inside edge variables are discarded and set 624 to a previous value such that the estimate of the plateau no longer contains a lower score. In other words, one side of the plateau from the trial value is discarded. One of the lower or upper outside edge variables are also set to the trial parameter value, depending on which side of the plateau is discarded.

Which side of the plateau is discarded can be determined in a number of ways. For example, the upper side can always be discarded in such cases, such that the upper inside edge variable is reset to a previous value less than the trial value. Alternatively, the lower side can always be discarded in such cases, such that the lower inside edge variable is reset to a previous value greater than the trial value. In a further alternative, it can be determined which side of the plateau is currently smaller, or has fewer samples, and discard this side.

It is then determined 626 whether all the trial values in the trial set have been sampled. If not, then the next value in the trial set is selected 628, scored 610 and the variables updated accordingly. If all the trial values in the trial set have been sampled, then the size of the gaps between the lower inside and outside edge variables, and the upper inside and outside edge variables are calculated 630. In other words, it is determined how close the estimates of the inside and outside edges are to each other.

It is determined 632 whether the size of both gaps are less than a predefined threshold. If not, this indicates that the samples are not yet sufficient to have an accurate estimate of the location and extent of the plateau. In this case, a new trial set for sampling is calculated 634. In one example, the new trial set can comprise two trial values, one at each of the midpoints of the gaps between the inside and outside edges. Selecting a new trial set in this way halves the gap size, and draws the samples more closely to the edge area. The values in the new trial set can then be evaluated in the same way as described above.

If it is determined 632 that the size of both gaps are less than the predefined threshold, then this indicates that an accurate estimate of the location and extent of the plateau has been found. A parameter value from the plateau can then be selected 636 as the optimum value. In other words, the range of values between the lower and upper inside edge variables are estimates to all have the maximum score (i.e. are on the plateau) and hence a value can be selected from this range to be the optimum value.

The selection of an optimum value from this range of values can be performed in a number of ways. For example, one of the lowest, highest or middle value from the range can always be selected. The selection can also be based on the type of parameter. For example, in the case that the parameter determines the size of the area of a region, then the largest value can be selected as this avoids small regions being formed on the input device, which may be difficult for a user to control. Once the optimum value for the parameter has been selected, it is output 638 from the optimization process. Further parameters can then be optimized as outlined above with reference to FIG. 5.

In order to graphically illustrate the operation of the optimization process, reference is now made to FIG. 7, which shows an example of an optimization process in operation. FIG. 7 shows a plot for a given parameter with score 702 on the vertical axis, and parameter value 704 on the horizontal axis. The dashed line 706 shows the behavior of the score with parameter value for this parameter. However, the precise nature of the dashed line 706 is not known, and can only be determined with certainty by testing every value for the parameter. The purpose of the optimization process above is to determine some features of the dashed line 706 without sampling all values for the parameter. As described above, the optimization process attempts to determine the extent of a plateau in the dashed line 706 at which the score has a maximum value.

In this illustrative example, the predefined minimum value for the parameter is at point 708, and the predefined maximum value is at point 710. Therefore, when the optimization process starts, the lower and upper outside edge variables are set to point 708 and 710 respectively. An initial value “A” is selected for the parameter, and a corresponding score 712 determined. The initial plateau height variable is then set to score 712, and the lower and upper inside edge variables set to value “A”.

A trial set of five values “B” to “F” are selected, spaced substantially evenly between the minimum and maximum values. Value “B” is found to have a score of 714, which is lower than the current plateau height, and between the current lower inside and outside edge, and hence the lower outside edge is set to value “B”. Value “C” is found to have a score of 716, which is also lower than the current plateau height, and between the current upper inside and outside edge, and hence the upper outside edge is set to value “C”. Value “D” is found to have a score 718 that is higher than the current plateau height, so the lower and upper inside edges are set to “D”, and the current plateau height set to score 718. Value “E” has a score 720 that is equal to the current plateau height, and is greater than the upper inside edge, so the upper inside edge is set to “E”.

At this point in the optimization process, it is estimated that the plateau extends from at least “D” to “E” (as the lower and upper inside edges), and “B” and “C” are outside the plateau (as the lower and upper outside edges). To determine whether more analysis is needed the gaps between the lower inside and outside edges (i.e. “D” minus “B”) and the upper inside and outside edges (i.e. “C” minus “E”) are calculated. In this example, these are greater than the threshold, and a new trial set having value “G” and “H” is selected at the midpoints of the gaps.

Value “G” is found to have score 724, which is lower than the current plateau height, and between the current lower inside and outside edge, and hence the lower outside edge is set to value “G”. Value “H” has score 726 which is lower than the current plateau height, but within the current estimate of the plateau. This shows that the current plateau estimate is not correct (as can be seen from the dashed line 706). In this illustrative example, the upper side of the plateau is discarded in these cases, and hence the upper inside limit is changed from its current value of “E” to its previous value of “D” (which is less than “H”). The upper outside limit is set to “H”.

The gaps between the lower inside and outside edges (i.e. “D” minus “G”) and the upper inside and outside edges (i.e. “H” minus “D”) are calculated, and in this example determined to be greater than the threshold, so the process continues. A new trial set having value “I” and “J” is selected at the midpoints of the gaps.

Value “I” has score 728, which is lower than the current plateau height, and between the current lower inside and outside edge, and hence the lower outside edge is set to value “I”. Value “J” has a score 730 that is equal to the current plateau height, and is greater than the upper inside edge, so the upper inside edge is set to “J”. The gaps between the lower inside and outside edges (i.e. “D” minus “I”) and the upper inside and outside edges (i.e. “H” minus “J”) are calculated. In this example, the gap between the lower inside and outside edges is less than the threshold. No further samples are illustrated in FIG. 7 in this gap, for clarity, although the process can optionally continue to narrow this gap. The gap between the upper inside and outside edges is determined to be greater than the threshold in this example, so the process continues. A new trial set having value “K” is selected at the midpoints of the gap.

Value “K” has score 732 below the current plateau height and between the upper inside and outside edges, and hence the upper outside edge is set to “K”. The gap between the upper inside and outside edges (“K” minus “J”) is determined to be greater than the threshold in this example, so the process continues. A new trial set having value “L” is selected at the midpoints of the gap. Value “L” has a score 734, which is below the current plateau height and between the upper inside and outside edges, and hence the upper outside edge is set to “L”. The gap between the upper inside and outside edges (“L” minus “J”) is evaluated, and found to be within the threshold. The sampling process then ceases, as it has been determined that samples have been found that are sufficiently close to the actual edges of the plateau (as shown in dashed line 702). The optimum value for the parameter can then be selected from the range “D” to “J”.

Note that the plot shown in FIG. 7 is merely for the purpose of illustrating the operation of the optimization process. In a real system, the shape of the plot can be different to that shown in FIG. 7. For example, it can be more common in real scenarios to only have a single plateau, rather than the two shown in FIG. 7.

Reference is now made to FIG. 8, which illustrates a flowchart of a process for scoring a parameter value. The process in FIG. 8 can be performed whenever a parameter value is to be scored in FIG. 6 or 7 above.

The score is initially set 800 to zero. The example gesture records are accessed, and the first example gesture record is selected 802. The data describing movement of one or more digits from the selected gesture record is passed through the gesture recognizer, which uses the set of parameter values, including the parameter value currently being scored. The output from the gesture recognizer is the identity of a gesture recognized (or alternatively an output indicating the absence of a recognized gesture). The output from the gesture recognizer is compared 806 to the gesture identify associated with the selected example gesture record, and it is determined 808 whether the gesture recognizer correctly detected the gesture.

If not, then is it determined 810 whether all the example gesture records have been tried, and if that is not the case, then the next example gesture record is selected 812 and passed through the gesture recognizer as above. If it is determined 808 that the gesture recognizer did correctly detected the gesture, then a weighting factor associated with the selected example gesture record is read 814, and the weighting factor added to the score 816. It is then determined whether more example gesture records remain to be evaluated, as above. Once all the example gesture records have been passed through the gesture recognizer, then the total score for the parameter value is output 818.

In one example, the weighing factors for all example gesture records can be equal. However, in other examples, the weighting factors can be different. For example, some gestures can be considered a higher priority to recognize correctly, and hence have a higher weighting. In other examples, the weightings can be dependent on the number of example gesture records that are present for each type of gesture. In other words, if a first gesture is only present in a single example gesture record, whereas a second gesture is present in many example gesture records, then the scoring will favor the second gesture. The weighting factor can be used to normalize the example gesture records, so that certain gestures are not favored.

Reference is now made to FIG. 9, which illustrates various components of computing device 108. Computing device 108 may be implemented as any form of a computing and/or electronic device in which the processing for the gesture recognition training techniques may be implemented.

Computing device 108 comprises one or more processors 902 which may be microprocessors, controllers or any other suitable type of processor for processing computer executable instructions to control the operation of the device in order to implement the gesture recognition training techniques.

The computing device 108 also comprises an input interface 904 arranged to receive and process input from one or more devices, such as the input device 102. The computing device 108 further comprises an output interface 906 arranged to output the user interface to display device 110.

The computing device 108 also comprises a communication interface 908, which can be arranged to communicate with one or more communication networks. For example, the communication interface 908 can connect the computing device 108 to a network (e.g. the internet). The communication interface 908 can enable the computing device 108 to communicate with other network elements to store and retrieve data.

Computer-executable instructions and data storage can be provided using any computer-readable media that is accessible by computing device 108. Computer-readable media may include, for example, computer storage media such as memory 910 and communications media. Computer storage media, such as memory 910, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store information for access by a computing device. In contrast, communication media may embody computer readable instructions, data structures, program modules, or other data in a modulated data signal, such as a carrier wave, or other transport mechanism. Although the computer storage media (such as memory 910) is shown within the computing device 108 it will be appreciated that the storage may be distributed or located remotely and accessed via a network or other communication link (e.g. using communication interface 908).

Platform software comprising an operating system 912 or any other suitable platform software may be provided at the memory 910 of the computing device 108 to enable application software 914 to be executed on the device. The memory 910 can store executable instructions to implement the functionality of a gesture recognition engine 916 (arranged to detect gestures using the regions and thresholds defined in the parameter set), an optimization engine 918 (arranged to optimize the parameters as per FIGS. 5 and 6), and a scoring engine 920 (arranged to score a given parameter from the example gesture records as per FIG. 8), as described above, when executed on the processor 902. The memory 910 can also provide a data store 924, which can be used to provide storage for data used by the processor 902 when performing the gesture recognition training technique, such as the annotated example gesture records and the variables used during optimization.

The term ‘computer’ is used herein to refer to any device with processing capability such that it can execute instructions. Those skilled in the art will realize that such processing capabilities are incorporated into many different devices and therefore the term ‘computer’ includes PCs, servers, mobile telephones, personal digital assistants and many other devices.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible (or non-transitory) storage media include disks, thumb drives, memory etc and do not include propagated signals. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description of a preferred embodiment is given by way of example only and that various modifications may be made by those skilled in the art. The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention.

1. A computer-implemented method of training a gesture recognizer to detect gestures performed by a user on an input device, the method comprising:
loading, from a storage device, a plurality of example gesture records, each comprising data describing movement of at least one digit on the input device when performing an identified gesture;
loading, from the storage device, a parameter set that defines spatial triggers used to detect gestures from data describing movement of at least one digit on the input device; and
determining, at a processor, a value for each parameter in the parameter set by: selecting a plurality of trial values; applying the example gesture records to the gesture recognizer with each trial value to determine a score for each trial value;
using the score for each trial value to estimate a range of values over which the score is a maximum; and selecting the value from the range of values.

2. A method according to claim 1, wherein the step of using the score for each trial value to estimate a range of values over which the score is a maximum comprises: determining the extent of a maximum-score plateau by using the scores for each trial value to estimate values corresponding to upper and lower edges of the plateau, and selecting the range of values from the plateau.

3. A method according to claim 1, wherein the step of determining a value for each parameter in the parameter set further comprises, prior to selecting a plurality of trial values:
selecting an initial value;
applying the example gesture records to the gesture recognizer with the initial value to determine a score for the initial value;
setting a plateau height variable to the score for the initial value;
setting a first inside edge variable and a second inside edge variable to the initial value;
setting a first outside edge variable to a predefined minimum value for the parameter; and
setting a second outside edge variable to a predefined maximum value for the parameter.

4. A method according to claim 3, wherein the step of using the score for each trial value to estimate a range of values over which the score is a maximum comprises:
determining whether the score for an associated trial value is greater than the plateau height variable, and, if so, setting the first inside edge variable and the second inside edge variable to the associated trial value.

5. A method according to claim 3, wherein the step of using the score for each trial value to estimate a range of values over which the score is a maximum comprises:
determining whether the score for an associated trial value is equal to the plateau height variable, and, if so, selecting one of the first or second inside edge variables, and setting it to the associated trial value.

6. A method according to claim 3, wherein the step of using the score for each trial value to estimate a range of values over which the score is a maximum comprises:
determining whether the score for an associated trial value is less than the plateau height variable and the associated trial value is between either the first inside edge variable and the first outside edge variable, or the second inside edge variable and the second outside edge variable, and, if so, selecting one of the first or second outside edge variables, and setting it to the associated trial value.

7. A method according to claim 3, wherein the step of using the score for each trial value to estimate a range of values over which the score is a maximum comprises:
determining whether the score for an associated trial value is less than the plateau height variable and the associated trial value is between the first inside edge variable and the second inside edge variable, and, if so, selecting one of the first or second inside edge variables and resetting it to a previous value.

8. A method according to claim 3, wherein the step of determining a value for each parameter in the parameter set further comprises: repeating the steps of selecting a plurality of trial values, applying the example gesture records, and using the score for each trial value, until the difference between the first inside edge variable and the first outside edge variable is less than a predefined threshold, and the difference between the second inside edge variable and the second outside edge variable is less than a predefined threshold.

9. A method according to claim 1, wherein the parameter set that defines spatial triggers comprises parameters defining a plurality of regions corresponding to zones on a touch-sensitive portion of the input device, wherein each region in the plurality of regions is associated with a distinct set of gestures that can be initiated from that region.

10. A method according to claim 1, wherein the parameter set that defines spatial triggers comprises parameters defining a plurality of threshold vectors, wherein each threshold vector is positioned relative to a start location of a gesture, and a gesture associated with a given threshold vector is triggered when movement of a digit on the input device crosses the given threshold vector.

11. A method according to claim 1, wherein the step of selecting a plurality of trial values comprises selecting a plurality of values spaced substantially evenly between a predefined minimum and maximum for the parameter.

12. A method according to claim 3, wherein the step of selecting a plurality of trial values comprises: selecting a first trial value between the first inside edge variable and the first outside edge variable; and selecting a second trial value between the second inside edge variable and the second outside edge variable.

13. A method according to claim 1, wherein the step of applying the example gesture records to the gesture recognizer with each trial value to determine a score for each trial value comprises, for each trial value:
i) selecting an example gesture record from the plurality of example gesture records;
ii) passing the example gesture record through the gesture recognizer with the trial value;
iii) comparing the gesture recognizer output to the identified gesture for the example gesture record;
iv) reading a weighting factor the identified gesture and adding the weighting factor to the score if the gesture recognizer output and the identified gesture match; and
repeating steps i) to iv) for each example gesture record in the plurality of example gesture records.

14. A method according to claim 1, wherein the step of selecting a value from the a range of values comprises:
selecting a minimum value from the range as the value;
selecting a maximum value from the range as the value; or selecting a mid-point value from the range as the value;

15. A method according to claim 1, further comprising repeating the step of determining a value for each parameter in the parameter set, until the value for each parameter differs by less than a predefined threshold between consecutive repetitions.

16. A method according to claim 1, wherein the step of determining is performed for each parameter in a first sequence, and the method further comprises repeating the step of determining in an opposite sequence to the first sequence.

17. A computer system for training a gesture recognizer to detect gestures performed by a user on an input device, comprising:
a memory arranged to store a parameter set that defines spatial triggers used to detect gestures from data describing movement of at least one digit on the input device, and a plurality of example gesture records, each comprising pre-recorded data describing movement of at least one digit on the input device when performing an identified gesture; and
a processor executing an optimization engine arranged to determine a value for each parameter in the parameter set, wherein the optimization engine is configured to: select a plurality of trial values; retrieve the example gesture records from the memory; apply the example gesture records to the gesture recognizer with each trial value to determine a score for each trial value; use the score for each trial value to estimate a range of values over which the score is a maximum; and select the value from the range of values and store the value in the parameter set at the memory.

18. A computer system according to claim 17, wherein the input device is a multi-touch mouse device.

19. A computer system according to claim 17, further comprising an input interface arranged to receive data from the input device, the data describing movement of at least one digit of a user on a touch-sensitive portion of the input device, and wherein the processor further executes a gesture recognition engine arranged to compare the data from the input device to the spatial triggers defined in the parameter set to detect a gesture applicable to the data, and execute a command associated with the gesture detected.

20. One or more tangible device-readable media with device-executable instructions that, when executed by a computing system, direct the computing system to perform steps comprising:
loading, from a memory, a plurality of example gesture records, each comprising pre-recorded data describing movement of at least one digit of one or more users on a touch-sensitive portion of a mouse device when performing an identified gesture;
loading, from the memory, a gesture recognizer parameter set that defines a plurality of regions corresponding to zones on the touch-sensitive portion of the mouse device, wherein each region in the plurality of regions is associated with a distinct set of gestures that can be initiated from that region;
determining a value for each parameter in the parameter set by: selecting a plurality of trial values; applying the example gesture records to the gesture recognizer with each trial value to determine a score for each trial value; using the score for each trial value to estimate a range of values over which the score is a maximum; and selecting the value from the range of values; and
storing the value for each parameter in the parameter set at the memory.
